(19) United States
(12) Patent Application Publication
(10) Pub. No.: US 2009/0123656 A1
(43) Pub. Date: May 14, 2009

(54) Composition and method for controlling galvanic corrosion in printed circuit boards

(76) Inventors: Ernest Long, Coventry (GB); Andrew Krol, Bristol, CT (US); Lenora M. Toscano, Waterbury, CT (US); Steven A. Castaldi, Torrington, CT (US)

Correspondence Address: ARTHUR G. SCHAIER;CARMODY & TORRANCE LLP, 50 LEAVENWORTH STREET, P.O. BOX 1110, WATERBURY, CT, 06721, US

(21) Appl. No.: 11/983,982

(22) Filed: Nov. 13, 2007

(51) Int. Cl. B05D 1/02; B32B 9/04; B05D 1/18; C04B 9/02

(52) U.S. Cl. 427/427; 106/14.14; 428/689; 427/443.2

(57) ABSTRACT

A composition for inhibiting the galvanic corrosion of printed circuit boards. The corrosion resistant coating composition may be applied to the printed circuit board to reduce corrosion and to shut down the chemical mechanism for galvanic corrosion so that corrosion protection of the product is achieved. The corrosion resistant coating composition comprises a) a mercaptan; b) an ethoxylated alcohol; and c) at least one metal species selected from the group consisting of molybdates, tungstates, vanadataes, zirconium, cobalt.

### FIELD OF THE INVENTION

The present invention is directed to an aqueous corrosion resistant coating composition for reducing corrosion on surfaces of printed circuit boards.

### BACKGROUND OF THE INVENTION

Printed circuit board (PCB) manufacturing processes typically comprise many steps, in part because of the increasing demand for enhanced performance. Surface circuits on PCBs usually include copper and copper alloy materials that are coated to provide good mechanical and electrical connection with other devices in the assembly. In the production of printed circuit boards, a first stage comprises preparing the circuit board and a second stage comprises mounting various components on the circuit board.

There are generally two types of components that are attachable to the circuit board: a) legged components, such as resistors, transistors, etc., which are attached to the circuit board by passing each of the legs through a hole in the board and then ensuring that the hole around the leg is filled with solder; and b) surface mount devices, which are attached to the surface of the board by soldering with a flat contact area or by adhesion with a suitable adhesive.

Plated through-hole printed circuit boards may generally be fabricated by a process comprising the following sequence of steps:
1) Drill holes through copper clad laminate;
2) Process boards through standard plated through hole cycle to plate electroless copper in the holes and on the surface;
3) Apply a plating mask;
4) Electrolytically plate copper to desired thickness in the holes and on the exposed circuitry;
5) Electrolytically plate tin in holes and on exposed circuitry to serve as an etch resist;
6) Strip the plating resist;
7) Etch the exposed copper (i.e., copper not plated with tin);
8) Strip the tin;
9) Apply, image and develop a soldermask such that the soldermask covers the substantially entire board surface except for the areas of connection; and
10) Apply protective solderable layer to the areas to be soldered.

Other sequences of steps may also be used and are generally well known to those skilled in the art. In addition, fresh water rinses may be interposed between each step. Other examples of sequences of steps that may be used to prepare the printed circuit boards in the first stage are described, for example, in U.S. Pat. No. 6,319,543 to Soutar et al., U.S. Pat. No. 6,656,370 to Toscano et al., and U.S. Pat. No. 6,815,126 to Fey et al., the subject matter of each of which is herein incorporated by reference in its entirety.

Solder masking is an operation in which the entire area of a printed circuit board, except solder pads, surface mount pads, and plated through-holes, is selectively covered with an organic polymer coating. The polymer coating acts like a dam around the pads to prevent the undesirable flow of solder during assembly and also improves the electrical insulation resistance between conductors and provides protection from the environment.

The solder mask compound is typically an epoxy resin that is compatible with the substrate. The solder mask may be screen printed onto the printed circuit board in the desired pattern or may also be a photoimageable solder mask that is coated onto the surface. Both types of solder masks are generally well known to those skilled in the art.

The contact areas include wire-bonding areas, chip attach areas, soldering areas and other contact areas. Contact finishes must provide good solderability, good wire bonding performance and high corrosion resistance. Some contact finishes must also provide high conductivity, high wear resistance, and high corrosion resistances. A typical prior art contact finish coating may include an electrolytic nickel coating with an electrolytic gold layer on top, although other coatings are also known to those skilled in the art.

Soldering is generally used for making mechanical, electromechanical, or electronic connections to a variety of articles. In the manufacture of electronic equipment utilizing printed circuits, connections of electronic components to the printed circuits are made by soldering of the leads of the components to the through-holes, surrounding pads, lands and other points of connection (collectively, “Areas of Connection”).

To facilitate this soldering operation, through-holes, pads, lands and other points of connection are arranged so that they are receptive to the subsequent soldering processes. Thus, these surfaces must be readily wettable by the solder and permit an integral conductive connection with the leads or surfaces of the electronic components. Because of these needs, printed circuit fabricators have devised various methods of preserving and enhancing the solderability of surfaces. Examples of such methods are described in U.S. Pat. No. 6,773,757 to Redline et al. and in U.S. Pat. No. 5,935,640 to Ferrier et al., the subject matter of each of which is herein incorporated by reference in its entirety.

As discussed in the U.S. Pat. No. 6,773,757 and the U.S. Pat. No. 5,935,640 patents (incorporated herein by reference), it is known that immersion silver deposits are excellent solderability preservatives, which are particularly useful in the fabrication of printed circuit boards. Immersion plating is a process which results from a replacement reaction whereby the surface being plated dissolves into solution and at the same time the metal being plated deposits from the plating solution onto the surface. The immersion plating typically initiates without prior activation of the surfaces. The metal to be plated is generally more noble than the surface metal. Thus immersion plating is usually significantly easier to control and significantly more cost effective than electroless plating, which requires sophisticated auto catalytic plating solutions and processes for activation of the surfaces prior to plating.

However, the use of immersion silver deposits can be problematic because of the possibility of solder mask interface attack (SMIA) wherein galvanic attack may erode the copper trace at the interface between the solder mask and the copper trace. SMIA is also known by other names such as solder mask crevice corrosion and simply galvanic attack at the solder mask interface. Regardless of the name, the problem comprises a galvanic attack at the solder mask-copper interface. This interfacial galvanic attack arises as a result of the soldermask-copper interfacial structure and the immersion plating mechanism.

Galvanic corrosion is caused by the junction of two dissimilar metals. Differences in the metal can be seen as composition of the metal itself varying, or differences in grain boundaries, or localized shear or torque from the manufacturing process. Almost any lack of homogeneity of the metal surface or its environment may initiate a galvanic corrosion attack, by causing a difference in potential. Contact between dissimilar metals also causes this galvanic current to flow, due to the difference in potential of the two, or more, different metals. Galvanic corrosion can occur when one metal is coated with a more noble metal, for example silver over copper. Any exposed copper can accelerate this process as well. Higher failure rates and accelerated corrosion are seen in environments that have high levels of reduced sulfur gasses such as elemental sulfur and hydrogen sulfide.

Circuit boards are normally composed of several different metals, including copper, tin and silver, given by way of example and not limitation. These metals are at different levels in the galvanic series, so they may galvanically react with each other. Thus, it would be desirable to develop a composition for treating printed circuit boards to reduce galvanic corrosion and prevent the chemical mechanism of galvanic corrosion as well.

The present invention in a broad aspect, relates to inhibiting the corrosion of metals. The invention more particularly concerns compositions and methods of controlling/inhibiting galvanic corrosion on surfaces of printed circuit boards.

### SUMMARY OF THE INVENTION

It is an object of the present invention to provide a corrosion resistant coating composition for reducing corrosion on surfaces of printed circuit boards.

It is another object of the present invention to provide a composition that can reduce galvanic corrosion on surfaces of printed circuit boards and as well slow down the chemical mechanism of galvanic corrosion.

To that end, the present invention relates to an aqueous corrosion resistant coating composition comprising:
a) a mercaptan;
b) preferably, an ethoxylated alcohol; and
c) at least one metal ionic species selected from the group consisting of molybdates, tungstates, vanadates, zirconium, cobalt and titanium.

In another embodiment, the present invention relates to a method of treating surfaces of substrates with the aqueous corrosion resistant coating composition to reduce corrosion thereon.

### DETAILED DESCRIPTION OF THE PREFERRED EMBODIMENTS

The present invention relates generally to an aqueous corrosion resistant coating composition comprising:
a) a mercaptan;
b) preferably, an ethoxylated alcohol; and
c) at least one metal ionic species selected from the group consisting of molybdates, tungstates, vanadataes, zirconium, cobalt and titanium.

In an optional, but preferred embodiment, the corrosion resistant coating composition also includes xanthan gum. If used, the concentration of xanthan gum is preferably from 1 to 10 g/l.

The ethoxylated alcohol is preferably a C-10 alcohol ethoxylate. However, other similar ethoxylated alcohols would also be known to those skilled in the art and would be usable in the present invention. If used, the concentration of ethoxylated alcohol is preferably 0.1 to 10 g/l.

In addition, various mercaptans are usable in the composition of the invention, including for example C12 to C18 chain length mercaptans. In a preferred embodiment, the mercaptan is stearyl mercaptan (1-octadecanethiol). The concentration of mercaptan is preferably from 1 to 20 g/l.

In addition, while various metal ionic species are usable in the composition of the invention, in one preferred embodiment, the at least one metal species is ammonium molybdate tetrahydrate. In another preferred embodiment, the at least one metal species is ammonium metatungstate and/or ammonium metavanadate. The concentration of metal species is preferably from 2 to 100 g/l.

While it is contemplated that components of the corrosion resistant coating composition are usable in any amount that will produce the desired result of reducing and/or elimination corrosion, in a preferred embodiment the corrosion resistant coating composition described herein comprises:

| | | |
|---|---|---|
| 1. | Xanthan gum | 0.10-1.0% by wt. |
| 2. | Ethoxylated alcohol (C-10) | 0.10-1.00% by wt. |
| 3. | Stearyl mercaptan | 0.10-2.00% by wt. |
| 4. | Ammonium molybdate tetrahydrate | 0.20-10.00% by wt. |
| 5. | Water | Balance |

The aqueous corrosion resistant coating composition of the invention is particularly suited for treating surfaces of printed circuit boards, including printed circuit boards having both copper and silver deposits, to reduce galvanic corrosion.

Thus, the present invention also relates to a method of treating surfaces of a printed circuit board to reduce corrosion thereon, the method comprising the step of:
contacting surfaces of the printed circuit board with an aqueous corrosion resistant coating composition comprising:
   a) a mercaptan;
   b) preferably, an ethoxylated alcohol; and
   c) at least one metal ionic species selected from the group consisting of molybdates, tungstates, vanadataes, zirconium, cobalt and titanium.

While various methods would be known to those skilled in the art for contacting the printed circuit board with the corrosion resistant coating composition of the invention, preferred methods include dipping, spraying and horizontal flooding. Other methods would also be known to those skilled in the art.

The compositions are preferably contacted with the printed circuit board at 50° C. and for a sufficient period of time to obtain the desired result. However, it is contemplated that temperatures between 20 to 70° C. would also be usable. In addition, the contact period is typically in the range of about 10 to 300 seconds.

By preventing corrosion on the printed circuit boards the useful life of the device can be extended. Furthermore, by eliminating corrosion, soldering problems can be completely eliminated, which is a major benefit for board, circuit and component manufacturers.

While the invention has been described above with reference to specific embodiments thereof, it is apparent that many changes, modifications, and variations can be made without departing from the inventive concept disclosed here. Accordingly, it is intended to embrace all such changes, modifications, and variations that fall within the spirit and broad scope of the appended claims. All patent applications, patents, and other publications cited herein are incorporated by reference in their entirety.

What is claimed is:

1. An aqueous corrosion resistant coating composition for printed circuit boards comprising:
a) a mercaptan;
b) at least one metal ionic species selected from the group consisting of molybdates, tungstates, vanadataes, zirconium, cobalt and titanium; and
c) optionally, an ethoxylated alcohol.

2. The corrosion resistant coating composition according to claim 1, comprising xanthan gum.

3. The corrosion resistant coating composition according to claim 1, wherein the mercaptan comprises stearyl mercaptan.

4. The corrosion resistant coating composition according to claim 2, wherein the mercaptan comprises stearyl mercaptan.

5. The corrosion resistant coating composition according to claim 1, wherein the at least one metal ionic species comprises ammonium molybdate tetrahydrate.

6. The corrosion resistant coating composition according to claim 4, wherein the at least one metal ionic species comprises ammonium molybdate tetrahydrate.

7. The corrosion resistant coating composition according to claim 1, wherein the at least one metal ionic species comprises ammonium metatungstate or ammonium metavanadate.

8. The corrosion resistant coating composition according to claim 1, wherein the mercaptan comprises a C12 to C18 chain length mercaptan.

9. The corrosion resistant coating composition according to claim 1, wherein the metal ionic species is present in the composition in an amount of about 0.20 to about 10.00 percent by weight, based on the total weight of the composition.

10. The corrosion resistant coating composition according to claim 1, wherein the mercaptan is present in the composition in an amount of about 0.10 to about 2.00 percent by weight, based on the total weight of the composition.

11. The corrosion resistant coating composition according to claim 1, wherein the ethoxylated alcohol is present in the composition in an amount of about 0.10 to about 1.00 percent by weight, based on the total weight of the composition.

12. The corrosion resistant coating composition according to claim 2, wherein the xanthan gum is present in the coating composition in an amount of about 0.10 to about 1.0 percent by weight, based on the total weight of the composition.

13. A method of treating surfaces of a printed circuit board to reduce corrosion thereon, the method comprising the step of:
contacting surfaces of the printed circuit board with an aqueous corrosion resistant coating composition comprising:
a) a mercaptan;
b) at least one metal ionic species selected from the group consisting of molybdates, tungstates, vanadataes, zirconium, cobalt and titanium; and
c) optionally, an ethoxylated alcohol.

14. The method according to claim 13, wherein the corrosion resistant coating composition comprises xanthan gum.

15. The method according to claim 13, wherein the printed circuit board is contacted with the corrosion resistant coating composition using a method selected from the group consisting of dipping, spraying and horizontal flooding.

16. The method according to claim 14, wherein the mercaptan comprises stearyl mercaptan.

17. The method according to claim 13, wherein the at least one metal ionic species comprises ammonium molybdate tetrahydrate.

18. The method according to claim 16, wherein the at least one metal ionic species comprises ammonium molybdate tetrahydrate.

19. The method according to claim 13, wherein the at least one metal ionic species comprises ammonium metatungstate or ammonium metavanadate.

20. The method according to claim 13, wherein the mercaptan comprises a C12 to C18 chain length mercaptan.
